(19) United States
(12) Patent Application Publication
(10) Pub. No.: US 2008/0144680 A1
(43) Pub. Date: Jun. 19, 2008

(54) Single Mode Light Source Device Having External Cavity

(76) Inventors: Yong D. Jeong, Chungcheongbuk-do (KR); Yong H. Won, Daejeon (KR); Doo W. Choi, Gyeonggi-do (KR)

Correspondence Address: NIXON & VANDERHYE, PC, 901 NORTH GLEBE ROAD, 11TH FLOOR, ARLINGTON, VA, 22203, US

(21) Appl. No.: 11/597,164

(22) PCT Filed: May 23, 2005
(86) PCT No.: PCT/KR2005/001494

§ 371 Date: Nov. 21, 2006

(30) Foreign Application Priority Data
May 25, 2004 (KR) 10-2004-0037353
May 10, 2005 (KR) 10-2005-0038814

(51) Int. Cl. H04B 10/02

(52) U.S. Cl. 372/32

(57) ABSTRACT

The present invention relates to a single mode light source device having an external cavity. The single mode light source device according to the present invention includes a laser diode, an integrated lens, and an optical fiber. The optical fiber has an incidence surface cleaved at a predetermined angle, such that a portion of light emitted from the laser diode is reflected to return to the laser diode. An internal cavity embedded in the laser diode is combined with an external cavity, thereby selecting only an optical signal of a single mode (wavelength) and outputting the selected optical signal. The external cavity is formed between a light emitting surface of the laser diode using multi mode oscillation and the incidence surface of the optical fiber. According to the present invention such constructed, the single mode light source can be embodied easily at a low price and also can be used as a variable wavelength light source.

### TECHNICAL FIELD

The present invention relates to a light source device, and more particularly, to a light source device of a single mode (wavelength) having an external cavity, which is usable in a Wavelength Division Multiplexing Network (WDM network) and the like.

### BACKGROUND ART

As demands for information traffic and various services increase, all kinds of analog and digital optical communication systems are being used. In an early optical communication, data transmission quantity has been increased through Time Division Multiplex (hereinafter, TDM). However, due to increase of information capacity and limit of an electronic device, a Wavelength Division Multiplexing (hereinafter, WDM) technology has been engrafted. The WDM technology can divide wavelengths of optical signals, thereby using the same.

In the WDM, light of various wavelengths is multiplexed and transmitted, and each wavelength is separated in the reverse at a receiving end. Main elements consist of an optical transmitter, an optical receiver, a wavelength multiplexer, a wavelength demultiplexer, an optical amplifier, an optical fiber, and an optical signal compensator. The optical transmitter is a key module among the above elements and most expensive.

The optical transmitter mainly uses Distributed Feedback-Laser Diode (hereinafter, DFB-LD) as a light source. While the DFB-LD has advantages such as high Side Mode Suppression Ratio (SMSR), high power, and narrow linewidth, it also has a disadvantage, such as high cost. Thus, there is a problem that the DFB-LD is hardly applicable in an optical access network employing the WDM since it regards the price most important.

In a current optical access network, there is being widely used a method in which each of users uses TDM/TDMA (time division multiplexer/time division multiple access) to divide bandwidth on a time. However, since the method divides a time to use the same, there is a disadvantage that a transmission speed decreases when there are many subscribers and it gets complicated to embody a protocol to locate each of subscriber data on a time without conflict with another subscriber data. Thus, many researchers are trying to embody a low cost WDM laser light source and adopt the embodied WDM laser light source to WDM-PON.

As a first method of such try, there is provided a method dividing and using an incoherent light source of wideband in an area of wavelengths. This method mainly uses LED, SLD (Single mode Laser Diode), an optical amplifier, and the like. At this time, there is a problem that LED is hard to be used due to its weak light power, SLD is expensive, and the optical amplifier needs an expensive external modulator in order to generate an optical signal.

As a second method, there is provided a method employing a Fabry-Perot laser as a light source. In this method, SMSR (side mod suppression ratio) increases by injecting an external beam into a low cost Fabry-Perot laser and causing a wavelength-locked phenomenon to reflect only a mode corresponding to a selected wavelength band. A coherent or incoherent beam can be injected as the external beam.

However, the aforementioned both methods have a disadvantage that an external light source generating external beams is expensive. Also, since structures thereof are complicated and the both rely on external beams, they have weak reliability.

As a third method, there is provided a method using a magnetic beam of a Fabry-Perot laser to cause wavelength locking. This method injects a magnetic beam into an optical fiber Fabry-Perot laser by using an optical fiber bragg grating filter. Thus, it is difficult to embody the method at a low price and to directly modulate the laser beam.

As another method, there is provided a method using a beam reflected from an optical fiber grating filter to the exterior of a Fabry-Perot laser diode to cause wavelength locking. This method is limited to making an optical pulse string by driving the Fabry-Perot laser diode with gain switching. Also, this method has a disadvantage that it is difficult to make a well-functional optical pulse due to optical interference between magnetic wavelengths.

Like above, while the Fabry-Perot laser diode has advantages, such as low price and simplified structure, it is a multi mode laser which oscillates various wavelengths simultaneously. Thus, the Fabry-Perot laser diode is not suitable for the WDM network. Also, even in case that only a single mode is selected using an optical wavelength filter, stable output cannot be oscillated due to a mode hopping phenomenon. Thus, the Fabry-Perot laser diode cannot be used in the WDM network.

### DISCLOSURE OF INVENTION

### Technical Goals

The present invention is conceived to provide an optimal single mode light source device which is usable in a WDM network (Wavelength Division Multiplexing Network).

The present invention also provides a single mode light source device which operates in a stable status and can be embodied at a low price.

The present invention also provides a single mode light source device which provides light of a single mode using a multi mode laser diode.

### Technical Solutions

In order to achieve the aforementioned goals, according to an aspect of the present invention, there is provided a single mode light source device, including: a laser diode including an internal cavity generating a plurality of optical signals with different wavelengths; an integrated lens integrating optical signals generated at the laser diode; and a transmission optical fiber transmitting optical signals integrated and projected by the integrated lens. An incidence surface onto which light of the optical fiber is projected is inclined at a predetermined angle and an external cavity is formed between the incidence surface of the optical fiber and a light emitting surface of the laser diode to oscillate the light source device in a single mode

A gradient of the incidence surface of the optical fiber is adjusted such that optical signals reflected from the incidence surface reach the laser diode again to resonate. At this time, the length of the external cavity can be set such that a phase alignment frequently occurs when light reflected from the incidence surface of the optical fiber is projected onto the laser diode. This is in order to prevent noise including an interference and unstable output.

### BRIEF DESCRIPTION OF DRAWINGS

FIG. 1 is a structure diagram of a single mode light source device according to an embodiment of the present invention;

FIG. 2 is a diagram illustrating a principle selecting a single mode using an external cavity, in a single mode light source device according to an embodiment of the present invention;

FIG. 3 is a diagram illustrating a spectrum of an existing multi mode light source and an a spectrum of a single mode light source device according to an embodiment of the present invention;

FIGS. 4 and 5 are diagrams illustrating an example of characteristics of modulation of a single mode light source device according to an embodiment of the present invention; and

FIG. 6 is a diagram illustrating an example of wavelength tunability of a single mode light source device according to an embodiment of the present invention.

### BEST MODE FOR CARRYING OUT THE INVENTION

Hereinafter, the present invention will be fully described with reference to the accompanying drawings, such that those skilled in the related art can readily implement the present invention. However, the present invention is not limited to embodiments disclosed herein and can be embodied in various forms.

According to an embodiment of the present invention, stabilized single mode oscillation is enabled without mode hoping by using a multi mode laser diode. For this, there is provided a new structure of a light source device, in which only a stabilized single mode is oscillated from various modes generating in the multi mode laser diode by controlling a gradient of an incidence surface of an optical fiber combined with the currently compatibilized multi mode laser diode, such as for example, a Fabry-Perot laser diode, thereby using a structure of gab between the laser diode and the optical fiber as a feed back cavity.

Hereinafter, a specific structure of a light source device according to an embodiment of the present invention will be described.

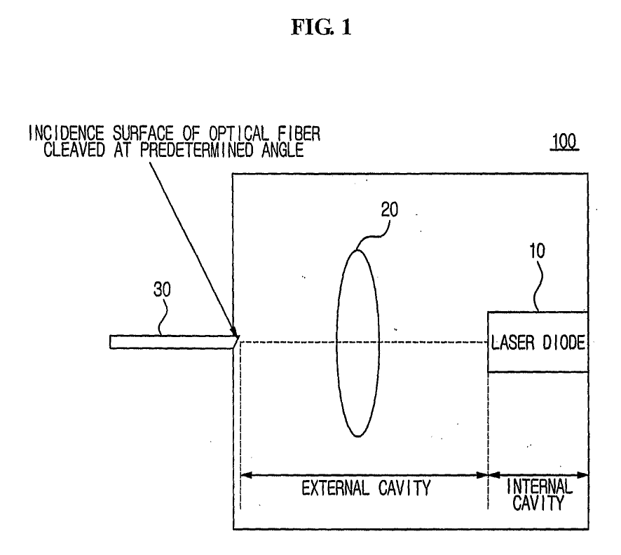

FIG. 1 is a structure diagram of a single mode light source device according to an embodiment of the present invention.

As illustrated in FIG. 1, the single mode light source device according to an embodiment of the present invention includes a laser diode 10 generating light, an integrated lens 20 integrating light generated at the laser diode 10, and an optical fiber 30 transmitting the integrated light through the lens 20.

The laser diode 10 is a multi mode laser diode generating light having various wavelengths simultaneously. For example, a laser diode chip of a Fabry Perot etalon structure can be used. The present embodiment employs the laser diode chip formed of the above structure, however, is not limited thereto. An interval between respectively different wavelengths generated at the laser diode 10 may be determined based on the length of the chip. Light emitted from the laser diode 10 may be spread at a predetermine angle.

The integrated lens 20 integrates light emitted from the laser diode 10 and transmits the integrated light to the optical fiber 30. The integrated lens 20 may be an aspherical or spherical lens. In the meantime, reflectivity of a cross section of the not specially treated optical fiber is approximately 15 dB, very small. In order to improve functions of an external cavity, the higher covering effects of the lens the better. Thus, the ashperical lens has an advantage over the spherical lens.

The optical fiber 30 transmits the light integrated by the integrated lens 20 to an unillustrated external device. Particularly, the optical fiber 30 is cleaved at a set angle of the incidence surface onto which the light is projected.

In the next, operations of a single mode light source device according to an embodiment of the present invention such constructed will be described.

Optical signals with different wavelengths are generated at the laser diode 10. The generated optical signals are transmitted to the optical fiber 30 by the integrated lens 20. At this time, some of, for example, approximately 4% of the optical signals integrated by the integrated lens 20 and having reached the optical fiber 30 are reflected due to a difference between medium refractive indexes, which is a difference between a refractive index of air and that of the optical fiber.

At this time, when the incidence surface of the optical fiber 30 is inclined at a predetermined angle, in other words, when the incidence surface is cleaved at a predetermined angle, it is possible to prevent optical signals reflected from the optical fiber 30 from projecting into the laser diode 10 again. When the incidence surface of the optical fiber 30 is cleaved at a predetermined angle, for example, at an angle of 6°˜8°, the reflected optical signals are not projected into the laser diode 10. At this time, when the angle is adjusted to be smaller than 6°˜8° or 0, most of the reflected light is projected into the laser diode 10 again. Thus, there is an effect that a cavity is formed between the incidence surface of the optical fiber 30 and a light emitting surface of the laser diode 10 from which light is emitted. Accordingly, in an embodiment of the present invention, a gradient of the incidence surface of the optical fiber 30 is set such that light reflected from the incidence surface reaches the laser diode again and resonates. The gradient of the incidence surface to form such resonance is named as “a setting angle” and the cavity formed such is named as “an external cavity”. Preferably, the setting angle is set on the basis of a fixed location and angle of the laser diode 10, such that light reflected from the cross section of the optical fiber 30 is projected into the laser diode 10 to the highest degree.

The external cavity is combined with an embedded cavity (hereinafter, “an internal cavity) of the laser diode 10 and causes a particular wavelength to be oscillated under a particular condition. That is, an optical signal of the particular wavelength is selected by the internal cavity of the laser diode 10 formed of the Fabry-Perot etalon structure and the external cavity formed between the laser diode 10 and the optical fiber 30.

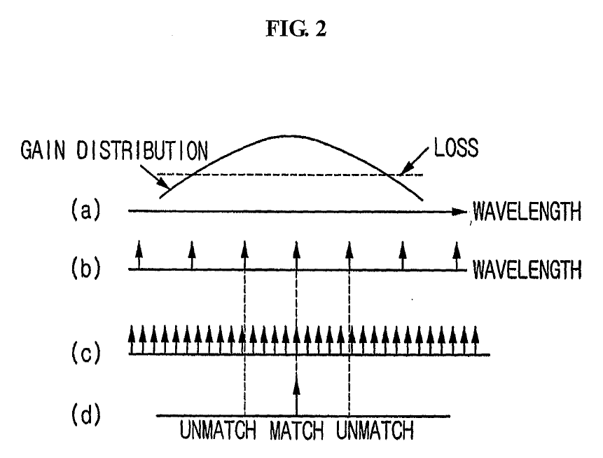

FIG. 2 is a diagram illustrating a principle wherein a particular wavelength, which is an optical signal of a single mode, is selected by combination of an external cavity and an internal cavity of a single mode light source device according to an embodiment of the present invention.

(a) of FIG. 2 illustrates a gain distribution of a laser diode. Only a wavelength of which a gain exceeds a loss among wavelengths selected by an internal cavity is oscillated. (b) of FIG. 2 illustrates a wavelength selected by the internal cavity of the laser diode and (c) of FIG. 2 illustrates one selected by the external cavity formed between a light emitting surface of the laser diode and a cutting plane of an optical surface.

An interval between wavelengths selected by each cavity is in inverse proportion to a refractive index of a medium and length of a cavity, which can be expressed as follows:

$$Δ λ = \frac{{λ}^{2}}{2 Ln} \qquad [ Equation 1 ]$$

At this time, Δλ is an interval between wavelengths, λ is a wavelength of a corresponding mode, L is the length of a cavity and n is a refractive index of a medium constituting the cavity.

In an embodiment of the present invention, the length of the external cavity is longer than that of the internal cavity. Thus, wavelengths selected at the external cavity by the equation 1 are spaced at narrower intervals. Oscillation of the laser diode 10 generates at a wavelength in which (b) of FIG. 2 is identical to (c) of FIG. 2 among wavelengths belonging to a gain distribution of (a) in FIG. 2. It is illustrated in (d) of FIG. 2. That is, among wavelengths selected at the internal cavity of the laser diode and those selected at the external cavity formed between the light emitting surface of the laser diode and the cutting plane of the optical fiber, only the wavelength identical to each other is selected.

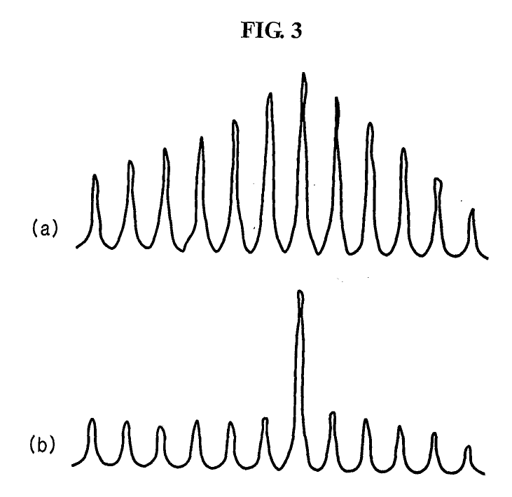

(a) of FIG. 3 illustrates an oscillation spectrum of a general Fabry-Perot laser diode and (b) of FIG. 3 illustrates an oscillation spectrum of a light source device having an external cavity according to an embodiment of the present invention. Referring to FIG. 3, in case of a conventional laser diode, a plurality of wavelengths is selected. In case of the light source device according to an embodiment of the present invention, as illustrated in (b) of FIG. 3, one wavelength is selected and other wavelengths are suppressed.

Experiments have been performed to prove that the wavelength selected such above is stably output.

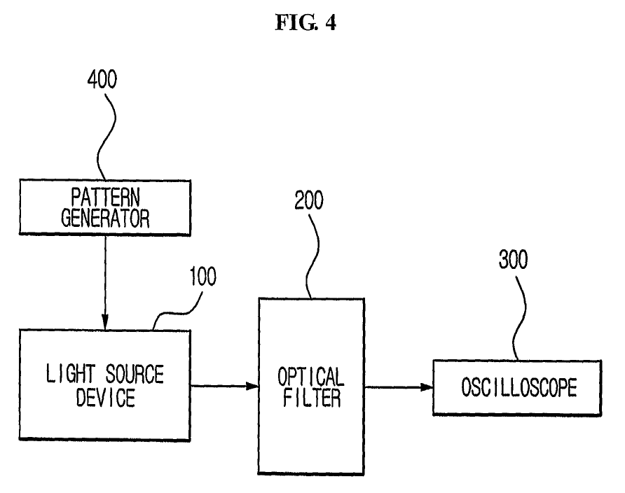

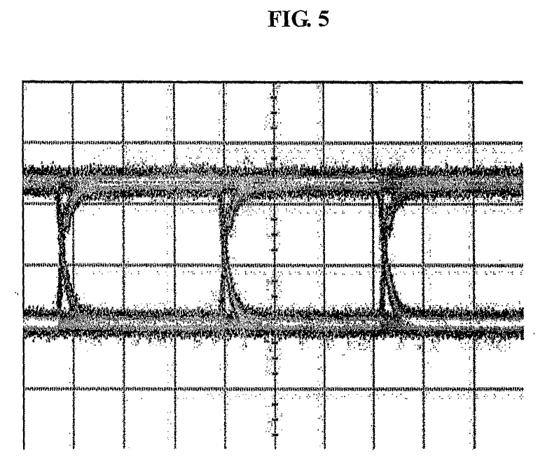

FIG. 4 is a diagram illustrating an experimental apparatus for measuring characteristics of a light source device according to an embodiment of the present invention, and FIG. 5 is diagram illustrating results measured by the experimental apparatus illustrated in FIG. 4.

As illustrated in FIG. 4, a modulation experiment is performed in such a manner that an optical filter 200 is connected to a light source device 100 according to an embodiment of the present invention and an oscilloscope 300 is connected to the optical filter 200. Output of the light source device 100 having an external cavity according to an embodiment of the present invention is transmitted to the optical filter 200 and passes therethrough. At this time, a pass band wavelength of the optical filter 200 is identical to a particular wavelength selected by combination of the internal cavity of the laser diode and the external cavity of the light source device according to an embodiment of the present invention. As a result of having observed optical signals passing through the optical filter 200 with the oscilloscope 300, results as illustrated in FIG. 5 were obtained. A modulation pattern is PRBS (pseudo random bit sequence) and as show in the figure, observation result by the oscilloscope 300 is very clean.

Accordingly, in case of the conventional Fabry-Perot laser diode, when a random wavelength is selected by an optical filter, a clean wave form cannot be obtained. However, in case of the light source device having an external cavity according to an embodiment of the present invention, only an optical signal of a particular wavelength can be selected.

In the meantime, an oscillation wavelength of a light source device according to an embodiment of the present invention can be adjusted using a temperature and bias current value. The oscillation wavelength is determined at a point where a resonance condition of the internal cavity of the laser diode formed of the Fabry-Perot etalon structure is identical to that of the external cavity.

The resonance condition of the external cavity formed between the light emitting surface of the laser diode and the incidence surface of the optical fiber does not change when locations of the laser diode and the optical fiber are fixed. Thus, it is good to set the length of the external cavity (distance between the light emitting surface of the laser diode and the incidence surface of the optical fiber), such that phase alignment frequently occurs when light reflected from the incidence surface of the optical fiber is reflected and projected onto the laser diode. This is in order to prevent noise including an interference and unstable output. Also, when the length of the external cavity is an integral multiple of the length of the internal cavity, phase alignment occurs simultaneously at a plurality of wavelengths. Thus, since single mode oscillation gets difficult, an integral multiple should be avoided.

However, a semiconductor laser diode may bring effects, such as the length of the internal cavity changes due to temperature or bias current, or the length changes due to a change in a refractive index. Thus, the wavelength selection criterion can be controlled by controlling the resonance condition of the internal cavity. That is, although the resonance condition of the external cavity as illustrated in (c) of FIG. 2 is fixed, the resonance condition of the internal cavity of (b) of FIG. 2 may change due to change in temperature and current. Consequently, the wavelength selection criterion determined by combination of the external cavity and the internal cavity becomes variable and a wavelength of a selected and output optical signal is also variable.

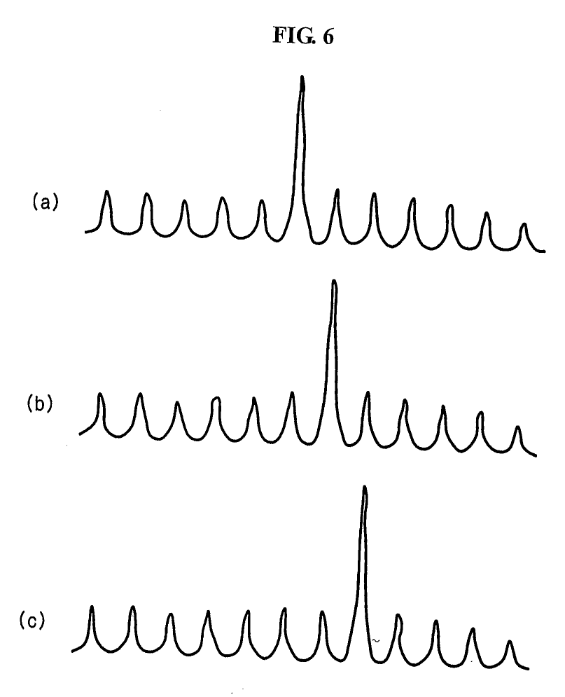

Like above, when a criterion of selecting a particular wavelength is satisfied, a variable wavelength is enabled in a gain distribution of the laser diode. Thus, the light source device according to an embodiment of the present invention can be used as a variable wavelength laser light source. FIG. 6 is a diagram illustrating change of an oscillation wavelength when the same laser diode is used and when temperature and current approved to the laser diode change, in a light source device according to an embodiment of the present invention.

While this invention has been particularly shown and described with reference to preferred embodiments thereof, this invention is not limited thereto. It will be apparent to those skilled in the related art that various changes in form and details may be made therein without departing from the spirit and scope of the invention as defined by the appended claims.

### INDUSTRIAL APPLICABILITY

As aforementioned, according to an embodiment of the present invention, there is provided a single mode light source device which operates in a stable status and can be embodied at a low price.

Particularly, as aforementioned, while a conventional laser diode uses a separate mirror or an optical fiber bragg grating in order to embody an external cavity, in an embodiment of the present invention, an incidence surface with which light emitted from a laser diode is combined is cleaved at a predetermined angle and used as a reflective surface. Thus, a simple and low cost light source device can be embodied using an existing packaging structure without a separate means.

A single mode light source device according to an embodiment of the present invention can be used as a light source of a WDM network (Wavelength Division Multiplexing network) and also, can be used as a variable wavelength light source. Particularly, the single mode light source device can be used as a low cost light source for WDM-PON.

1. A single mode light source device comprising:
a laser diode including an internal cavity generating a plurality of optical signals with different wavelengths;
an integrated lens integrating optical signals generated at the laser diode; and
a transmission optical fiber transmitting optical signals integrated and projected by the integrated lens;
wherein an incidence surface onto which light of the optical fiber is projected is inclined at a predetermined angle, and an external cavity is formed between the incidence surface of the optical fiber and a light emitting surface of the laser diode to oscillate the light source device in a single mode.

2. The device of claim 1, wherein:
the incidence surface of the optical fiber is inclined at an angle set such that light reflected from the incidence surface is projected onto the laser diode.

3. The device of claim 1, wherein:
the light source device is oscillated in a single mode by combination of the external cavity and the internal cavity of the laser diode and only an optical signal of a predetermined wavelength is output.

4. The device of claim 3, wherein:
the laser diode is a Fabry-Perot laser diode.

5. The device of claim 3, wherein:
the integrated lens is an aspherical lens.

6. The device of claim 3, wherein:
a resonance condition of the internal cavity changes by a current approved to the laser diode or temperature variation thereof.

7. The device of claim 2, wherein the light source device is oscillated in a single mode by combination of the external cavity and the internal cavity of the laser diode and only an optical signal of a predetermined wavelength is output.
